(19) United States
(12) Patent Application Publication
(10) Pub. No.: US 2026/0154246 A1
(43) Pub. Date: Jun. 4, 2026

(54) INFORMATION PROCESSING SYSTEM

(71) Applicant: TOYOTA JIDOSHA KABUSHIKI KAISHA, Toyota-shi (JP)

(72) Inventor: Tetsuya HASHIMOTO, Shinagawa-ku (JP)

(21) Appl. No.: 19/397,990

(22) Filed: Nov. 23, 2025

(30) Foreign Application Priority Data
Dec. 2, 2024 (JP) 2024-209622

(51) Int. Cl. G06F 16/215; G06F 40/194; G06N 5/04

(52) U.S. Cl. CPC G06F 16/215; G06F 40/194; G06N 5/04

(57) ABSTRACT

An information processing system includes a calculator that calculates a similarity between a first question sentence that is generated by a large language model based on first text data that is registered in a database, and a second question sentence that is generated by the large language model based on second text data that is registered in the database, a determiner that determines whether the similarity that is calculated is greater than a first threshold value, and a controller that deletes one of the first text data and the second text data when the similarity that is calculated is greater than the first threshold value.

### CROSS-REFERENCE TO RELATED APPLICATION

This application claims priority to Japanese Patent Application No. 2024-209622 filed on Dec. 2, 2024. The disclosure of the above-identified application, including the specification, drawings, and claims, is incorporated by reference herein in its entirety.

### BACKGROUND

### 1. Technical Field

The present disclosure relates to the technical field of information processing systems.

### 2. Description of Related Art

As an example of this type of system, a system has been proposed in which a language model is used to generate query data based on a document, and pairs of documents and query data are used to train a search model for a conversational bot (see Japanese Unexamined Patent Application Publication No. 2023-076413 (JP 2023-076413 A)).

### SUMMARY

As a conversation bot, a chatbot has been proposed that uses a mechanism (retrieval-augmented generation (RAG)) that combines large language models (LLMs) with a search of specific information sources (hereinafter referred to as “knowledge bases” as appropriate) to assign unique information sources to large language models. Here, the knowledge base includes a plurality of pieces of data (e.g., documents). For example, a knowledge base may include one piece of data, and other data that is a partial update of the one piece of data. For example, a knowledge base may contain a plurality of pieces of data with the same or nearly the same content. In such cases, there is a possibility that accuracy of the knowledge base search will deteriorate. It should be noted that a large language model is a language model that is constructed using a very large dataset and deep learning technology.

The present disclosure has been made in light of the above problems, and an object of thereof is to provide an information processing system that is capable of improving the accuracy of a knowledge base search.

An information processing system according to an aspect of the present disclosure includes a calculator that calculates a similarity between a first question sentence that is generated by a large language model based on first text data that is registered in a database, and a second question sentence that is generated by the large language model based on second text data that is registered in the database, a determiner that determines whether the similarity that is calculated is greater than a first threshold value, and a controller that deletes one of the first text data and the second text data when the similarity that is calculated is greater than the first threshold value.

An information processing system according to another aspect of the present disclosure includes a calculator that calculates a similarity between a first question sentence that is generated by a large language model based on first text data, and a second question sentence that is generated by the large language model based on second text data that is registered in a database, a determiner that determines whether the similarity that is calculated is greater than a first threshold value, and a controller that, when the similarity that is calculated is greater than the first threshold value, does not register the first text data in the database and maintains registration of the second text data, or registers the first text data in the database and deletes the second text data.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of an information processing system according to an embodiment;

FIG. 2 is a block diagram illustrating an example of a configuration of a computation device according to the embodiment;

FIG. 3 is a flowchart showing operations of the information processing system according to the first embodiment; and

FIG. 4 is a flowchart showing operations of the information processing system according to a second embodiment.

### DETAILED DESCRIPTION OF EMBODIMENTS

### First Embodiment

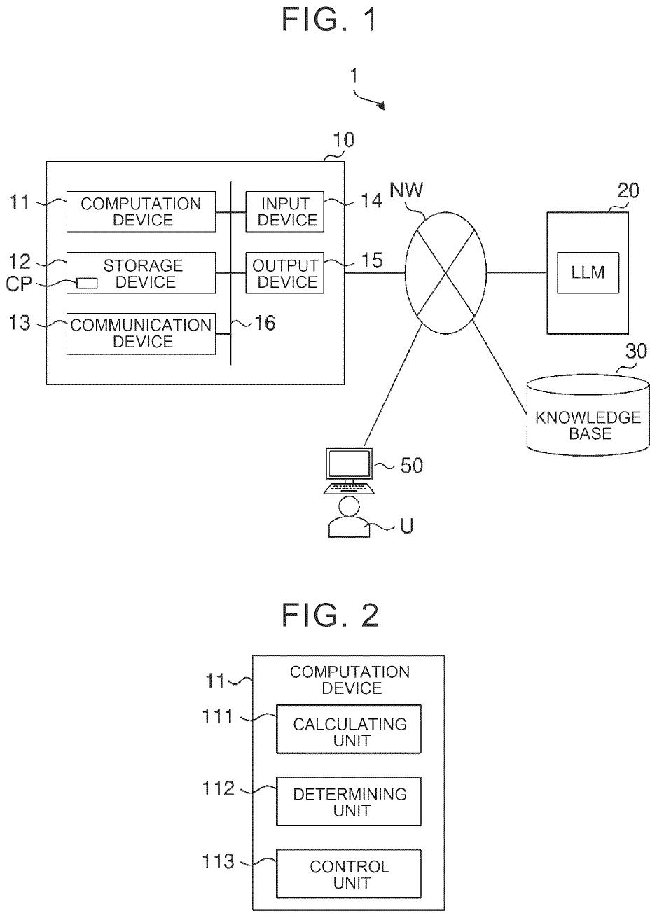

A first embodiment of an information processing system will be described with reference to FIGS. 1 to 3. In FIG. 1, an information processing system 1 includes an information processing device 10, a server 20, and a knowledge base 30. The information processing device 10, the server 20, and the knowledge base 30 are configured to be able to communicate with each other via a network NW. The server 20 is a server for operating a large language model (LLM). For this reason, the server 20 may be referred to as an LLM server. Note that the server 20 may be a cloud server.

### Chatbot

The server 20 and the knowledge base 30 may provide a chatbot service using retrieval-augmented generation (RAG). For example, a user U may use the chatbot service via a terminal device 50. In this case, the user U may operate the terminal device 50 to launch an application for using the chatbot service. The user U may operate the terminal device 50 to input a question sentence into an input field of the chat application. Here, “question sentences” are not limited to interrogative sentences. For example, a “question sentence” may be a sentence including an expression of a request, an instruction, a command, or the like, such as “please teach me about so-and-so”, “answer me about so-and-so”, and so forth. Accordingly, the term “question sentence” is not limited to interrogative sentences, and is a concept that includes sentences including expressions such as requests, instructions, commands, and so forth. In other words, a “question sentence” may mean a statement that requests a reply from the other party.

The terminal device 50 may search the knowledge base 30 based on a question sentence that is input. The terminal device 50 may transmit first information including the question sentence that is input, and text data as a search result of the knowledge base 30, to the server 20. The server 20 may input the question sentence and the text data that are contained in the first information into the large language model, as a prompt. The server 20 may acquire a reply to the question sentence, that is output from the large language model. The server 20 may transmit second information indicating the reply to the terminal device 50. The terminal device 50 that receives the second information may display the reply that is indicated by the second information on a screen related to the chat application. Note that the terminal device 50 may be a personal computer, a tablet terminal, or a smartphone.

### Information Processing Device 10

In FIG. 1, the information processing device 10 includes a computation device 11, a storage device 12, a communication device 13, an input device 14, and an output device 15. The computation device 11, the storage device 12, the communication device 13, the input device 14, and the output device 15, are connected via a data bus 16. Note that the information processing device 10 may be a personal computer, a tablet terminal, or a smartphone.

The computation device 11 may include a processor. Note that the computation device 11 may have a single processor or may have a plurality of processors. That is to say, the computation device 11 may have one or more processors. Note that the processor may be a multi-core processor. When the computation device 11 has a single processor that is a multi-core processor, it can be said that the computation device 11 logically has multiple processors.

The processor may be, for example, at least one of a central processing unit (CPU), a graphics processing unit (GPU), a field programmable gate array (FPGA), and a tensor processing unit (TPU).

The storage device 12 may be, for example, at least one of random access memory (RAM), read-only memory (ROM), a hard disk device, a magneto-optical disk device, a solid state drive (SSD), and an optical disk array. That is to say, the storage device 12 may be realized by a single device, or may be realized by a plurality of devices.

The communication device 13 may be capable of communicating with devices that are external to the information processing device 10. Note that the communication device 13 may perform wired communication or wireless communication.

The input device 14 is a device that is capable of externally accepting input of information to the information processing device 10. The input device 14 may include an operation device (e.g., a keyboard, a mouse, a touch panel, or the like) that can be operated by a user of the information processing device 10. The input device 14 may include a recording medium reading device that is capable of reading information recorded in a recording medium that is detachably attachable to the information processing device 10, such as, for example, Universal Serial Bus (USB) memory, and so forth. Note that when information is input to the information processing device 10 via the communication device 13 (i.e., when the information processing device 10 acquires information via the communication device 13), the communication device 13 may function as an input device.

The output device 15 is a device that is capable of outputting information externally from the information processing device 10. The output device 15 may have a display device that is capable of outputting visual information such as characters, images, and so forth, as the above information. Note that the output device 15 may have a speaker that is capable of outputting auditory information such as audio or the like, as the above information. The output device 15 may have a vibration motor that is capable of outputting tactile information such as vibrations and so forth, as the above information. The output device 15 may include a printer. The output device 15 may be capable of outputting information to a recording medium that is detachably attachable to the information processing device 10, such as, for example, USB memory or the like. Note that when the information processing device 10 outputs information via the communication device 13, the communication device 13 may function as an output device.

The storage device 12 is capable of storing desired data. The storage device 12 may store a computer program CP that is executed by the computation device 11. The storage device 12 may temporarily store data that is temporarily used by the computation device 11, when the computation device 11 is executing the computer program CP.

Note that the computer program CP may be recorded in a computer-readable, non-transitory recording medium. In this case, the computer program CP may be stored in the storage device 12 by reading the recording medium using a recording medium reading device, omitted from illustration, that is included in the information processing device 10. Note that at least one of an optical disc, a magnetic medium, a magneto-optical disc, semiconductor memory, and any other medium that is capable of storing a program, may be used as the recording medium. Note that the computer program CP may be acquired from a device, omitted from illustration, that is external from the information processing device 10, via the communication device 13. In other words, the computer program CP may be downloaded from an external device to the storage device 12 of the information processing device 10.

The computation device 11 (e.g., processor) may execute the processing to be performed by the information processing device 10 along with the storage device 12 in which the computer program CP is stored (i.e., along with the storage device 12 and the computer program CP stored in the storage device 12). For example, the computation device 11 may execute the computer program CP to realize, within the computation device 11 (e.g., within the processor), logical functional blocks for executing the processing to be performed by the information processing device 10.

### Knowledge Base 30

The knowledge base 30 may have a plurality of pieces of text data registered therein. The text data may be data that is obtained by dividing text that is contained in one document. Such data may be referred to as a “chunk”. Note that methods for dividing text contained in one document include, for example, a method of dividing at a certain length (i.e., fixed length), a method of dividing into increments of sentences based on sentence delimiters, a method of dividing based on a structure such as Markdown or the like, and so forth. Note that the knowledge base 30 may register each of a plurality of pieces of text data in a vectorized form. That is to say, the knowledge base 30 may be a vector database/vector store. In addition to text data, image data may be registered in the knowledge base 30.

Now, the present inventors have discovered the following matters through research. That is to say, new text data may be registered in the knowledge base 30 at any time. On the other hand, there is a possibility that a plurality of pieces of text data having the same or nearly the same contents will be registered in the knowledge base 30, or that pre-update text data and post-update text data will be registered. Furthermore, when searching the knowledge base 30, there is a possibility that two or more pieces of text data with duplicative contents will be extracted, or that pre-update text data and post-update text data will be extracted. As a result, there is a possibility that the search accuracy of the knowledge base 30 will deteriorate. In other words, in the chatbot service that is described above, there is a possibility that the accuracy of replies from the large language model will deteriorate.

Accordingly, the information processing device 10 according to the present embodiment manages a plurality of pieces of text data that is registered in the knowledge base 30. As illustrated in FIG. 2, the computation device 11 of the information processing device 10 has a calculating unit 111, a determining unit 112, and a control unit 113 in order to manage text data. The calculating unit 111, the determining unit 112, and the control unit 113 may be realized as the above-described logical functional blocks. Note, however, that at least one of the calculating unit 111, the determining unit 112, and the control unit 113 may be realized as a physical processing circuit. Alternatively, at least one of the calculating unit 111, the determining unit 112, and the control unit 113 may be realized by a combination of logical functional blocks and physical processing circuits.

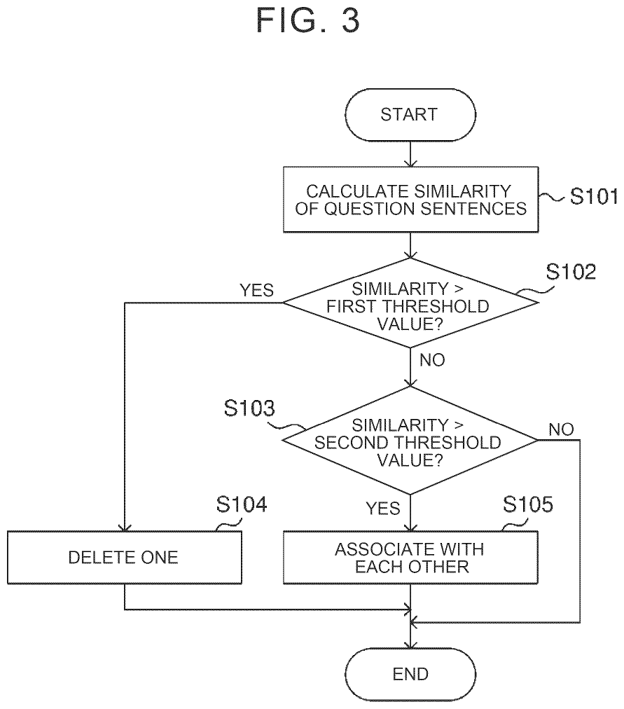

Operations of the information processing device 10 will be described with reference to the flowchart in FIG. 3. In FIG. 3, the computation device 11 of the information processing device 10 selects first text data and second text data that are registered in the knowledge base 30. The computation device 11 transmits the first text data and information (e.g., a prompt) for causing the large language model to generate a question sentence based on the first text data, to the server 20 via the communication device 13. As a result, the large language model generates a first question sentence based on the first text data. Also, the computation device 11 transmits the second text data and information (e.g., a prompt) for causing the large language model to generate a question sentence based on the second text data, to the server 20 via the communication device 13. As a result, the large language model generates a second question sentence based on the second text data. For example, when the text data is “Asakusa in Tokyo is a popular tourist spot for foreigners”, the large language model may generate the question sentence, “What are popular tourist spots in Tokyo for foreigners?”

The server 20 transmits the first question sentence and the second question sentence to the information processing device 10. The calculating unit 111 of the information processing device 10 calculates similarity between the first question sentence and the second question sentence (step S101). Note that the similarity that is calculated in the processing of step S101 may indicate that the greater a value thereof is, the more similar the first question sentence and the second question sentence are. For example, the similarity may be a cosine similarity. Note that “similarity” is “degree of agreement”.

The determining unit 112 of the information processing device 10 determines whether the similarity that is calculated in the processing of step S101 is greater than a first threshold value (step S102). When determination is made in the processing of step S102 that the similarity is greater than the first threshold value (Yes in step S102), the control unit 113 of the information processing device 10 deletes one of the first text data and the second text data from the knowledge base 30 (step S104).

For example, the control unit 113 may delete one of the first text data and the second text data from the knowledge base 30 based on at least one of an update date and time, and version information. In this case, the control unit 113 may delete the text data with the oldest update date and time from among the first text data and the second text data. The control unit 113 may delete, from the first text data and the second text data, the text data of which the version is an older version, as indicated by the version information.

When determination is made in the processing of step S102 that the similarity is smaller than the first threshold value (No in step S102), the determining unit 112 determines whether the similarity is greater than a second threshold value (step S103). Now, the second threshold value is a value that is smaller than the first threshold value. When determination is made in the processing of step S103 that the similarity is greater than the second threshold (i.e., first threshold value>similarity>second threshold value) (Yes in step S103), the control unit 113 associates the first text data with the second text data (step S105).

In the processing of step S103, when determination is made that the similarity is not greater than the second threshold value (No in step S103), the control unit 113 maintains the registration of the first text data and the second text data.

The “first threshold value” is a value for determining whether to delete one of the first text data and the second text data. The “second threshold value” is a value for determining whether to associate the first text data with the second text data. The first threshold value and the second threshold value may be fixed values that are set in advance, or may be variable values in accordance with some parameter. The first threshold value and the second threshold value may be set based on a relation between a degree of duplication in the contents of the two text data and the similarity between two question sentences generated based on each of the two pieces of text data by a large language model, respectively. Note that in the processing of step S102, a similarity that is equal to the first threshold value may be handled by being included in either one of the cases. Similarly, in the processing of step S103, a similarity that is equal to the second threshold value may be handled by being included in either one of the cases.

### Technical Effects

According to the information processing system 1 of the first embodiment, duplicative text data and the like can be deleted from a plurality of pieces of text data that is registered in the knowledge base 30. Thus, according to the information processing system 1, registration of text data that has been registered in a duplicative manner can be suppressed from being maintained, registration of both pre-update text data and post-update text data can be suppressed from being maintained, and so forth. Hence, according to the information processing system 1, accuracy of searching the knowledge base 30 can be improved. In addition, costs of using the storage that makes up the knowledge base 30 can be reduced.

Also, in the information processing system 1 according to the first embodiment, when the similarity between the first question sentence and the second question sentence is smaller than the first threshold value and also greater than the second threshold value, the first text data and the second text data are associated with each other. In searching the knowledge base 30, text data that is associated with each other may be treated as a group of text data.

### Second Embodiment

A second embodiment of the information processing system will be described with reference to FIGS. 1, 2, and 4. The second embodiment is the same as the first embodiment that is described above, except that operations of the information processing device 10 is partially different. Accordingly, description that is repetitive of that in the first embodiment that is described above will be omitted as appropriate.

When new text data is to be registered in the knowledge base 30, the information processing device 10 according to the second embodiment determines whether to register this text data in the knowledge base 30. The computation device 11 of the information processing device 10 has the calculating unit 111, the determining unit 112, and the control unit 113, in order to perform this determination.

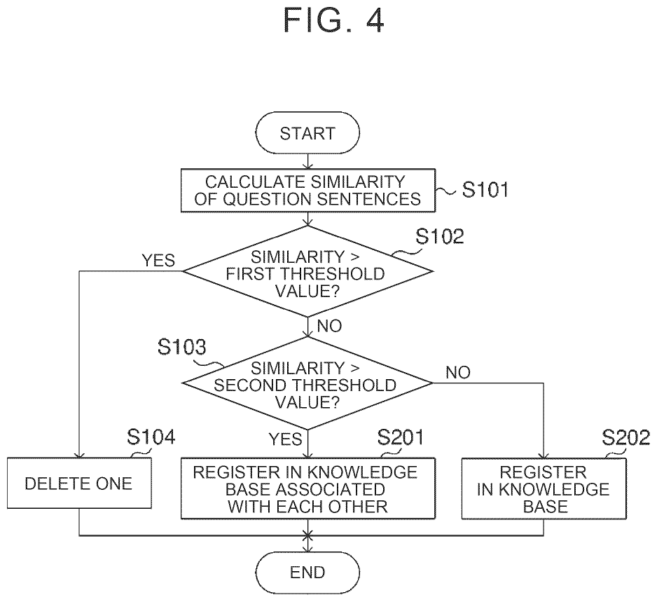

Operations of the information processing device 10 according to the second embodiment will be described with reference to the flowchart in FIG. 4. In FIG. 4, the computation device 11 of the information processing device 10 transmits new text data (i.e., text data that is newly registered in the knowledge base 30, hereinafter referred to as “third text data” as appropriate), and information (e.g., a prompt) for causing the large language model to generate a question sentence based on the third text data, to the server 20 via the communication device 13. As a result, the large language model generates a third question sentence based on the third text data. Also, the computation device 11 selects fourth text data that is registered in the knowledge base 30. The computation device 11 transmits the fourth text data and information (e.g., a prompt) for causing the large language model to generate a question sentence based on the fourth text data, to the server 20 via the communication device 13. As a result, the large language model generates a fourth question sentence based on the fourth text data.

The server 20 transmits the third question sentence and the fourth question sentence to the information processing device 10. The calculating unit 111 of the information processing device 10 calculates similarity between the third question sentence and the fourth question sentence (step S101).

The determining unit 112 of the information processing device 10 determines whether the similarity that is calculated in the processing of step S101 is greater than the first threshold value (step S102). When determination is made in the processing of step S102 that the similarity is greater than the first threshold value (Yes in step S102), the control unit 113 of the information processing device 10 deletes one of the third text data and the fourth text data (step S104). That is to say, the control unit 113 may maintain the registration of the fourth text data, without registering the third text data in the knowledge base 30 (in this case, the third text data may be deleted). Alternatively, the control unit 113 may register the third text data in the knowledge base 30 and delete the fourth text data.

For example, the control unit 113 may delete one of the third text data and the fourth text data based on at least one of an update date and time, and version information. In this case, the control unit 113 may delete the text data with the oldest update date and time from among the third text data and the fourth text data. The control unit 113 may delete, from among the third text data and the fourth text data, the text data of which the version is an older version, as indicated by the version information.

When determination is made in the processing of step S102 that the similarity is smaller than the first threshold value (No in step S102), the determining unit 112 determines whether similarity is greater than the second threshold value (step S103). When determination is made in the processing of step S103 that the similarity is greater than the second threshold (i.e., first threshold value>similarity>second threshold value) (Yes in step S103), the control unit 113 registers the third text data in the knowledge base 30, in a manner associated with the fourth text data (step S201).

When determination is made in the processing of step S103 that the similarity is smaller than the second threshold value (No in step S103), the control unit 113 registers the third text data in the knowledge base 30 (step S202).

### Technical Effects

According to the information processing system 1 according to the second embodiment, registration of a plurality of pieces of text data with the same or nearly the same contents, registration of both pre-update text data and post-update text data, and so forth, can be suppressed. Hence, according to the information processing system 1, accuracy of searching the knowledge base 30 can be improved. In addition, costs of using the storage that makes up the knowledge base 30 can be reduced.

Also, in the information processing system 1 according to the second embodiment, when the similarity between the third question sentence and the fourth question sentence is smaller than the first threshold value and also greater than the second threshold value, the third text data and the fourth text data are associated with each other. In searching the knowledge base 30, text data that is associated with each other may be treated as a group of text data.

Various aspects of the disclosure derived from the above-described embodiments will be described below.

An information processing system according to an aspect of the disclosure includes a calculator that calculates a similarity between a first question sentence that is generated by a large language model based on first text data that is registered in a database, and a second question sentence that is generated by the large language model based on second text data that is registered in the database, a determiner that determines whether the similarity that is calculated is greater than a first threshold value, and a controller that deletes one of the first text data and the second text data when the similarity that is calculated is greater than the first threshold value. In the above-described embodiment, “knowledge base 30” corresponds to an example of “database”, “calculating unit 111” corresponds to an example of “calculator”, “determining unit 112” corresponds to an example of “determiner,” and “control unit 113” corresponds to an example of “controller”.

In the information processing system according to the above aspect, when the similarity that is calculated is smaller than the first threshold value, the determiner may determine whether the similarity that is calculated is greater than a second threshold value that is smaller than the first threshold value, and when the similarity that is calculated is greater than the second threshold value, the controller may associate the first text data and the second text data with each other.

An information processing system according to another aspect of the disclosure includes a calculator that calculates a similarity between a first question sentence that is generated by a large language model based on first text data, and a second question sentence that is generated by the large language model based on second text data that is registered in a database, a determiner that determines whether the similarity that is calculated is greater than a first threshold value, and a controller that, when the similarity that is calculated is greater than the first threshold value, does not register the first text data in the database and maintains registration of the second text data, or registers the first text data in the database and deletes the second text data.

In the information processing system according to the above aspect, when the similarity that is calculated is smaller than the first threshold value, the determiner may determine whether the similarity that is calculated is greater than a second threshold value that is smaller than the first threshold value, and when the similarity that is calculated is greater than the second threshold value, the controller may register the first text data in the database in a manner associated with the second text data.

The present disclosure is not limited to the above-described embodiments, and may be modified as appropriate without departing from the gist or concept of the disclosure as can be read from the claims and the entire specification, and information processing systems involving such modifications are also included in the technical scope of the present disclosure.

What is claimed is:

1. An information processing system, comprising:
a calculator that calculates a similarity between a first question sentence that is generated by a large language model based on first text data that is registered in a database, and a second question sentence that is generated by the large language model based on second text data that is registered in the database;
a determiner that determines whether the similarity that is calculated is greater than a first threshold value; and
a controller that deletes one of the first text data and the second text data when the similarity that is calculated is greater than the first threshold value.

2. The information processing system according to claim 1, wherein
when the similarity that is calculated is smaller than the first threshold value, the determiner determines whether the similarity that is calculated is greater than a second threshold value that is smaller than the first threshold value, and
when the similarity that is calculated is greater than the second threshold value, the controller associates the first text data and the second text data with each other.

3. An information processing system, comprising:
a calculator that calculates a similarity between a first question sentence that is generated by a large language model based on first text data, and a second question sentence that is generated by the large language model based on second text data that is registered in a database;
a determiner that determines whether the similarity that is calculated is greater than a first threshold value; and
a controller that, when the similarity that is calculated is greater than the first threshold value, does not register the first text data in the database and maintains registration of the second text data, or registers the first text data in the database and deletes the second text data.

4. The information processing system according to claim 3, wherein
when the similarity that is calculated is smaller than the first threshold value, the determiner determines whether the similarity that is calculated is greater than a second threshold value that is smaller than the first threshold value, and
when the similarity that is calculated is greater than the second threshold value, the controller registers the first text data in the database in a manner associated with the second text data.
